(19) United States
(12) Patent Application Publication
(10) Pub. No.: US 2026/0331727 A1
(43) Pub. Date: Oct. 22, 2026

(54) FUSE UNIT AND CONDUCTIVE MODULE

(71) Applicant: YAZAKI CORPORATION, Tokyo (JP)

(72) Inventors: Kota Morishige, Makinohara-shi (JP); Katsunori Sato, Makinohara-shi (JP); Yasuhiro Kominato, Makinohara-shi (JP); Mariko Nakagawa, Makinohara-shi (JP); Miho Suzuki, Makinohara-shi (JP)

(21) Appl. No.: 19/647,385

(22) Filed: Apr. 14, 2026

(30) Foreign Application Priority Data
Apr. 17, 2025 (JP) 2025-067881

(51) Int. Cl. H01M 50/569; H01M 10/42; H01M 50/503; H01M 50/583; H01M 50/586; H01M 50/593

(52) U.S. Cl. CPC H01M 50/569; H01M 10/425; H01M 50/503; H01M 50/583; H01M 50/586; H01M 50/593; H01M 2010/4271

(57) ABSTRACT

A circuit protection component connects a first electrode to a first connection surface, and connects a second electrode to a second connection surface. In the first electrical connection unit, a first through hole is provided with a hole diameter less than an interval between first and second electrical connection units in the arrangement direction. In the second electrical connection unit, a second through hole is provided with a hole diameter less than an interval between the first and second electrical connection units. A pair of coating holding units holds a coating resin unit, and is disposed on an imaginary line in the arrangement direction in which the first through hole, the first connection surface, the second connection surface, and the second through hole are arranged.

### CROSS-REFERENCE TO RELATED APPLICATION(S)

The present application claims priority to and incorporates by reference the entire contents of Japanese Patent Application No. 2025-067881 filed in Japan on Apr. 17, 2025.

### BACKGROUND OF THE INVENTION

### 1. FIELD OF THE INVENTION

The present invention relates to a fuse unit and a conductive module.

### 2. DESCRIPTION OF THE RELATED ART

A conductive module electrically connects a plurality of battery cells in a battery module in which the plurality of battery cells are arranged in an arrangement direction by directly electrically connecting terminal connection units of a plurality of connection conductors to electrode terminals of battery cells to be connected. For example, the connection conductor includes a terminal connection unit formed for each of two electrode terminals adjacent in the arrangement direction of a pair of battery cells. The conductive module electrically connects each connection conductor to a battery monitoring unit that monitors a battery state of the battery cell using a wiring component such as an electric wire. For example, JP 2020 – 119 651 A discloses such a type of conductive module. In such a conductive module, a combination of paired connection conductor and conductor unit of the wiring component is provided for each connection conductor, and a circuit protection component such as a fuse may be interposed between the connection conductor and the conductor unit of the wiring component in each combination. A fuse unit (which is formed of a chip fuse, a pair of terminal fittings, and a resin portion) applied to the conductive module is connected directly electrically to a terminal connection unit of a connection conductor. For example, JP 7 561 318 B2 discloses such a fuse unit.

Incidentally, in a battery module, an inter-electrode terminal pitch between adjacent battery cells may change with respect to a nominal value within a design tolerance range in accordance with thermal expansion and thermal contraction of the battery cells at the time of use, a manufacturing tolerance variation of the battery cells, and an assembly tolerance variation of the plurality of battery cells. Therefore, in a conductive module, by providing a tolerance absorbing function of absorbing a change in inter-electrode terminal pitch in the connection conductor provided with two terminal connection units, an interval between the two terminal connection units can change in accordance with a change in the inter-electrode terminal pitch. Here, when the interval between the two terminal connection units changes, the conductive module transmits movement from one terminal connection unit to the fuse unit. Thus, in the fuse unit, a force associated with positional displacement of one terminal connection unit is applied. Therefore, it is necessary to prevent an overload from acting on the connection unit of each component.

### SUMMARY OF THE INVENTION

Accordingly, an object of the present invention is to provide a fuse unit and a conductive module that can withstand a change in inter-electrode terminal pitch.

In order to achieve the above mentioned object, a fuse unit according to one aspect of the present invention includes a circuit protection component configured to fuse a fusible portion when an overcurrent flows between a connection conductor that is connected directly electrically to two electrode terminals of a pair of battery cells of a battery module in which a plurality of battery cells are arranged in an arrangement direction, the two electrode terminals being adjacent to each other in the arrangement direction, and a battery monitoring unit that monitors a battery state of the battery cells; a first terminal fitting including a conductor connection unit to be connected directly electrically to the connection conductor and a first electrical connection unit provided with a first connection surface for directly electrically connecting a first electrode of the circuit protection component, the first terminal fitting having a flat plate shape protruding from the connection conductor in a direction orthogonal to the arrangement direction in a state where the first connection surface is oriented in the arrangement direction; a second terminal fitting including a flat plate-shaped second electrical connection unit provided with a second connection surface for directly electrically connecting a second electrode of the circuit protection component, and connected indirectly electrically to the battery monitoring unit; a coating resin unit having an electrically insulating property and enclosing the first electrical connection unit, the second electrical connection unit in which the second connection surface is disposed at an interval in the arrangement direction on the same plane with respect to the first connection surface, and the circuit protection component disposed across the first connection surface and the second connection surface; and a pair of coating holding units configured to hold the coating resin unit by sandwiching the coating resin unit from one end and the other end in the arrangement direction and allow the battery module to hold the coating resin unit, wherein the connection conductor is deformable in the arrangement direction in accordance with a change in an interval between the two electrode terminals in the arrangement direction, and wherein, in the first electrical connection unit, a first through hole formed to be positioned on a side opposite to the second connection surface in the arrangement direction with respect to the first connection surface is provided with a hole diameter less than an interval between the first electrical connection unit and the second electrical connection unit in the arrangement direction, wherein, in the second electrical connection unit, a second through hole formed to be positioned on a side opposite to the first connection surface in the arrangement direction with respect to the second connection surface is provided with a hole diameter less than the interval between the first electrical connection unit and the second electrical connection unit, and wherein the pair of coating holding units is disposed on an imaginary line in the arrangement direction in which the first through hole, the first connection surface, the second connection surface, and the second through hole are arranged.

In order to achieve the above mentioned object, a conductive module according to another aspect of the present invention includes a connection conductor connected directly electrically to two electrode terminals of a pair of battery cells of a battery module in which a plurality of battery cells are arranged in an arrangement direction, the two electrode terminals being adjacent to each other in the arrangement direction; a fuse unit configured to indirectly electrically connect the connection conductor to a battery monitoring unit that monitors a battery state of the battery cell; and a housing component assembled to the battery module and configured to house the connection conductor and the fuse unit, wherein the connection conductor is deformable in the arrangement direction in accordance with a change in an interval between the two electrode terminals in the arrangement direction, wherein the fuse unit includes a circuit protection component that fuses a fusible portion when an overcurrent flows between the connection conductor and the battery monitoring unit, a first terminal fitting including a conductor connection unit to be connected directly electrically to the connection conductor and a first electrical connection unit provided with a first connection surface for directly electrically connecting a first electrode of the circuit protection component, the first terminal fitting having a flat plate shape protruding from the connection conductor in a direction orthogonal to the arrangement direction in a state where the first connection surface is oriented in the arrangement direction, a second terminal fitting including a flat plate-shaped second electrical connection unit provided with a second connection surface for directly electrically connecting a second electrode of the circuit protection component, and connected indirectly electrically to the battery monitoring unit, a coating resin unit having an electrically insulating property and enclosing the first electrical connection unit, the second electrical connection unit in which the second connection surface is disposed at an interval in the arrangement direction on the same plane with respect to the first connection surface, and the circuit protection component disposed across the first connection surface and the second connection surface, and a pair of coating holding units configured to hold the coating resin unit by sandwiching the coating resin unit from one end and the other end in the arrangement direction and allow the battery module to hold the coating resin unit, wherein, in the first electrical connection unit, a first through hole formed to be positioned on a side opposite to the second connection surface in the arrangement direction with respect to the first connection surface is provided with a hole diameter less than an interval between the first electrical connection unit and the second electrical connection unit in the arrangement direction, wherein, in the second electrical connection unit, a second through hole formed to be positioned on a side opposite to the first connection surface in the arrangement direction with respect to the second connection surface is provided with a hole diameter less than the interval between the first electrical connection unit and the second electrical connection unit, and wherein the pair of coating holding units is provided in the housing component and is disposed on an imaginary line in the arrangement direction in which the first through hole, the first connection surface, the second connection surface, and the second through hole are arranged.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a fuse unit and a conductive module according to an embodiment;

FIG. 2 is a schematic diagram illustrating a battery module together with a connection conductor;

FIG. 3 is a perspective view illustrating the fuse unit according to the embodiment;

FIG. 4 is a plan view illustrating the fuse unit according to the embodiment;

FIG. 5 is an exploded perspective view illustrating the fuse unit according to the embodiment; and

FIG. 6 is a cross-sectional view taken along line X-X of FIG. 4.

### DETAILED DESCRIPTION OF THE PREFERRED EMBODIMENTS

Hereinafter, embodiments of a fuse unit and a conductive module according to the present invention will be described in detail with reference to the drawings. The present invention is not limited by the embodiments.

### Embodiment

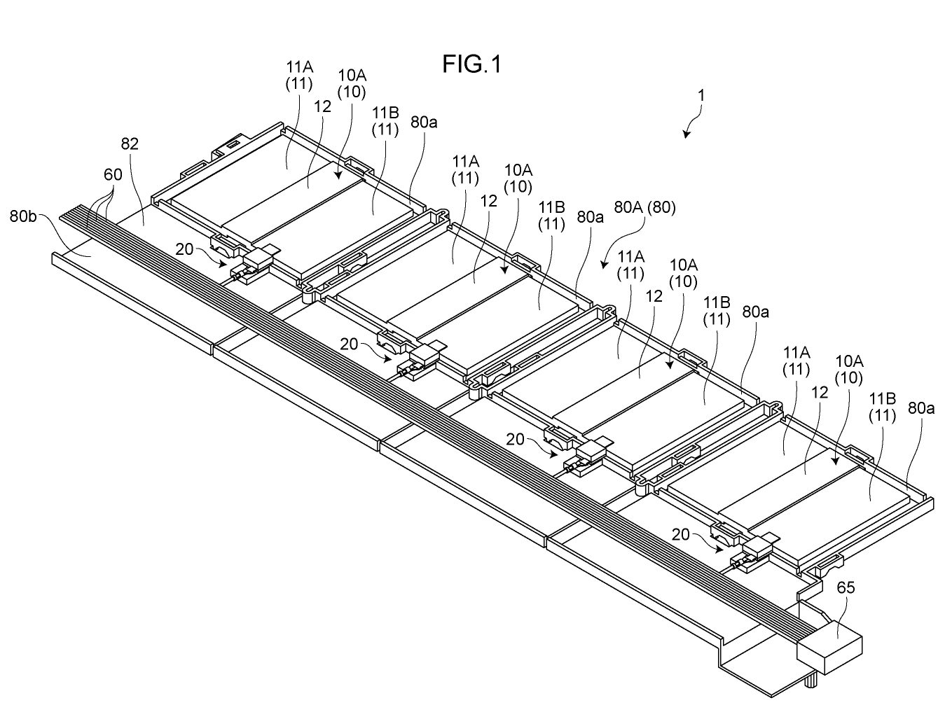

One of embodiments of a fuse unit and a conductive module according to the present invention will be described with reference to FIGS. 1-6.

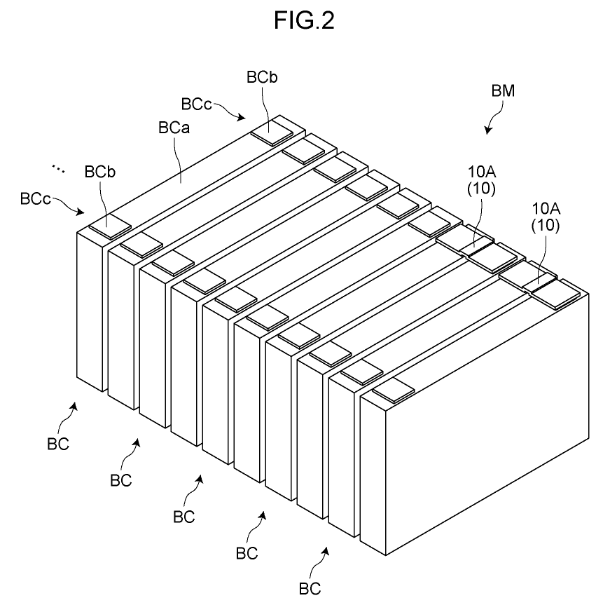

Reference numeral 1 in FIG. 1 denotes a conductive module according to the present embodiment. The conductive module 1 is assembled to a battery module BM (FIG. 2) in which a plurality of battery cells BC are arranged in an arrangement direction, and electrically connects the plurality of battery cells BC in the battery module BM. In the conductive module 1, the battery monitoring unit is allowed to monitor the battery state of the battery cell BC by electrically connecting the battery module BM to a battery monitoring unit (not illustrated). The conductive module 1 forms a battery pack together with the battery module BM. The battery pack is mounted in, for example, a vehicle (a battery electric vehicle (BEV), a hybrid electric vehicle (HEV), or the like) including a rotary machine as a drive source, and is used to supply power to the rotary machine.

The battery cell BC includes a cell body BCa and positive and negative electrode terminals BCb (FIG. 2). In the battery module BM, a plurality of the battery cells BC are arranged in a row in the arrangement direction. The battery module BM includes one electrode terminal group BCc in which one electrode terminal BCb of each of the plurality of battery cells BC is arranged in the arrangement direction, and the other electrode terminal group BCc in which the other electrode terminal BCb of each of the plurality of battery cells BC is arranged in the arrangement direction (FIG. 2).

Hereinafter, when the term "arrangement direction" is not particularly mentioned, the direction is an arrangement direction of the plurality of battery cells BC and an arrangement direction of the plurality of electrode terminals BCb in the electrode terminal group BCc.

In the battery cell BC illustrated here, the cell body BCa is formed in a rectangular parallelepiped shape that has six outer wall surfaces. In the plurality of battery cells BC, the cell bodies BCa adjacent to each other in the arrangement direction are arranged so that one outer wall surface faces the other wall surface. For example, in the battery cell BC, the positive and negative electrode terminals BCb are arranged in one of the six outer wall surfaces of the cell body BCa or in two of the six outer wall surfaces of the cell body BCa. In this example, each battery cell BC includes positive and negative electrode terminals BCb on one of the six outer wall surfaces of the cell body BCa (FIG. 2). Accordingly, in the battery module BM, two electrode terminal groups BCc are provided on one plane (FIG. 2).

The electrode terminal BCb illustrated here is formed in a flat plate shape, and a connection conductor 10 to be described below is connected directly electrically by laser welding or the like (FIG. 2). However, the electrode terminal BCb may be formed in a pole shape having a male screw unit. In this case, the connection conductor 10 is screwed and fixed to the electrode terminal BCb by screwing a female screw member to the male screw unit of the electrode terminal BCb.

The conductive module 1 includes the connection conductor 10 connected directly electrically to the electrode terminal BCb of the battery cell BC included in the battery module BM (FIGS. 1 and 2).

The connection conductor 10 is formed of a conductive material such as metal, and is connected directly electrically to the electrode terminal BCb of one or a pair of battery cells BC in the battery module BM. The connection conductor 10 is a plate-shaped conductive member called a bus bar, and is press-molded using a metal plate as a base material.

The connection conductor 10 is provided with a terminal connection unit 11 which is connected directly electrically to the electrode terminal BCb (FIG. 1). The terminal connection unit 11 is connected directly electrically to the electrode terminal BCb by laser welding.

The connection conductor 10 includes a conductor connected directly electrically to one electrode terminal BCb serving as a total negative electrode in the battery module BM and a conductor connected directly electrically to one electrode terminal BCb serving as a total positive electrode in the battery module BM.

Furthermore, the connection conductor 10 includes conductor connected directly electrically to two electrode terminals BCb adjacent in the arrangement direction of a pair of battery cells BC in the battery module BM (hereinafter referred to as a "connection conductor 10A") (FIGS. 1 and 2).

The connection conductor 10A includes, as the terminal connection unit 11, a first terminal connection unit 11A connected directly electrically to one of the two electrode terminals BCb adjacent in the arrangement direction, and a second terminal connection unit 11B connected directly electrically to the other of the two electrode terminals BCb (FIG. 1). The first terminal connection unit 11A and the second terminal connection unit 11B illustrated here are formed in a rectangular flat plate shape on the same plane. The first terminal connection unit 11A and the second terminal connection unit 11B are formed in the same rectangular shape.

Here, as described above, in the battery module BM, an inter-electrode terminal pitch (that is, an interval in the arrangement direction between two electrode terminals BCb adjacent to each other in the arrangement direction) of the battery cells BC adjacent in the arrangement direction may change with respect to a nominal value within a design tolerance range in accordance with thermal expansion and thermal contraction of the battery cells BC at the time of use, a manufacturing tolerance variation of the battery cells BC, and an assembly tolerance variation of the plurality of battery cells BC. Accordingly, the connection conductor 10A is formed to be deformable in the arrangement direction in accordance with a change in inter-electrode terminal pitch. For example, the connection conductor 10A is a unit that performs the tolerance absorbing function described above, and includes an interval adjusting unit 12 that is provided between the first terminal connection unit 11A and the second terminal connection unit 11B and can adjust an interval between the first terminal connection unit 11A and the second terminal connection unit 11B in the arrangement direction (FIG. 1). When a force in the arrangement direction is generated between the first terminal connection unit 11A and the second terminal connection unit 11B, for example, the interval adjusting unit 12 bends itself in the arrangement direction to change the interval between the first terminal connection unit 11A and the second terminal connection unit 11B. Thus, in the connection conductor 10A, when the inter-electrode terminal pitch changes, the interval between the first terminal connection unit 11A and the second terminal connection unit 11B can be changed to follow this change.

The conductive module 1 includes a fuse unit 20 that indirectly electrically connects the connection conductor 10 to the battery monitoring unit (FIGS. 1 and 3-5). The fuse unit 20 indirectly electrically connects the connection conductor 10 to the battery monitoring unit, and interrupts energization when an overcurrent flows therebetween. The fuse unit 20 is provided for each connection conductor 10.

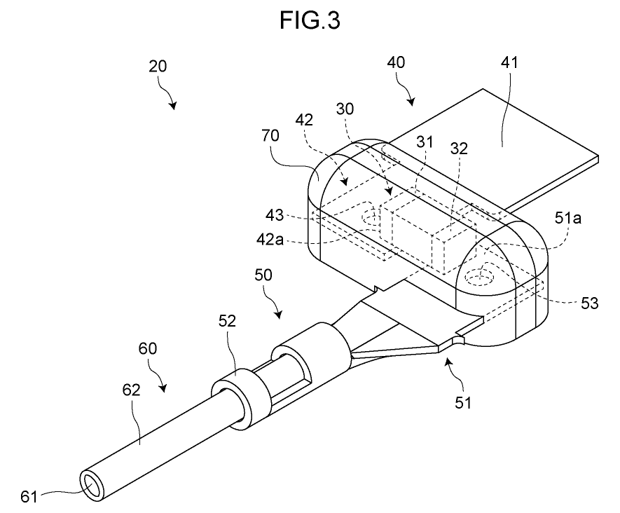

The fuse unit 20 includes a circuit protection component 30 that fuses a fusible portion when an overcurrent flows between the connection conductor 10 and the battery monitoring unit (FIGS. 3-5). This circuit protection component 30 includes a first electrode 31 and a second electrode 32 arranged with the fusible portion therebetween (FIGS. 3-5). The first electrode 31 and the second electrode 32 are arranged on a straight line by being separated at one end and the other end of the circuit protection component 30.

The circuit protection component 30 may be configured as, for example, a chip fuse that has a fusible portion, or may be configured as a pattern fuse in which a wiring pattern having a fusible portion is provided on a printed circuit board (for example, a flexible printed circuit board). The circuit protection component 30 illustrated here is configured as a rectangular chip fuse. The first electrode 31 is provided over five outer wall surfaces at one end of the circuit protection component 30. The second electrode 32 is provided over the five outer wall surfaces at the other end of the circuit protection component 30.

The fuse unit 20 includes a first terminal fitting 40 connected directly electrically to the circuit protection component 30 and a second terminal fitting 50 connected indirectly electrically to the battery monitoring unit (FIGS. 3-5). The first terminal fitting 40 and the second terminal fitting 50 are formed of a conductive material such as metal. For example, the first terminal fitting 40 and the second terminal fitting 50 are press-molded using a metal plate as a base material.

The first terminal fitting 40 includes a conductor connection unit 41 that is connected directly electrically to the connection conductor 10 (FIGS. 3-5). The conductor connection unit 41 is formed in a flat plate shape, and is placed on the connection conductor 10 so that flat surfaces overlap each other. The conductor connection unit 41 is connected directly electrically to the connection conductor 10 by laser welding, ultrasonic bonding, or the like. For example, the conductor connection unit 41 is placed on the second terminal connection unit 11B of the connection conductor 10A so that the flat surfaces overlap each other, and is connected directly electrically to the second terminal connection unit 11B by laser welding or the like. The conductor connection unit 41 illustrated here is formed in a rectangular flat plate shape.

Furthermore, the first terminal fitting 40 includes a first electrical connection unit 42 connected directly electrically to the first electrode 31 of the circuit protection component 30 (FIGS. 3-5). The first electrical connection unit 42 is formed in a flat plate shape, and the first electrode 31 is connected directly electrically to one of the two planes by laser welding, soldering, or the like. In the first electrical connection unit 42, a first connection surface 42a directly electrically connecting the first electrode 31 is provided in a part of one of the two planes (FIGS. 3-5). The first electrical connection unit 42 protrudes from the connection conductor 10 in a direction orthogonal to the arrangement direction in a state where the first connection surface 42a is oriented in the arrangement direction. For example, in the first electrical connection unit 42, the first connection surface 42a is parallel to a plane of the second terminal connection unit 11B of the connection conductor 10A, and protrudes from the second terminal connection unit 11B in the direction orthogonal to the arrangement direction.

The first terminal fitting 40 illustrated here is formed in one flat plate shape in which the conductor connection unit 41 and the first electrical connection unit 42 are adjacent to each other in the direction orthogonal to the arrangement direction.

The second terminal fitting 50 includes a second electrical connection unit 51 connected directly electrically to the second electrode 32 of the circuit protection component 30 (FIGS. 3-5). The second electrical connection unit 51 is formed in a flat plate shape, and the second electrode 32 is connected directly electrically to one of the two planes by laser welding, soldering, or the like. In the second electrical connection unit 51, a second connection surface 51a directly electrically connecting the second electrode 32 is provided in a part of one of the two planes (FIGS. 3-5).

The second electrical connection unit 51 is disposed at an interval in the arrangement direction with respect to the first electrical connection unit 42. In the second electrical connection unit 51, the second connection surface 51a is disposed at an interval in the arrangement direction on the same plane with respect to the first connection surface 42a of the first electrical connection unit 42. The circuit protection component 30 is disposed across the first connection surface 42a and the second connection surface 51a.

As described above, the second terminal fitting 50 is connected indirectly electrically to the battery monitoring unit. The fuse unit 20 includes a wiring component 60 interposed between the second terminal fitting 50 and the battery monitoring unit (FIGS. 3-5), and indirectly electrically connects the second terminal fitting 50 to the battery monitoring unit via the wiring component 60. The second terminal fitting 50 includes a wiring connection unit 52 connected directly electrically to the wiring component 60 (FIGS. 3-5).

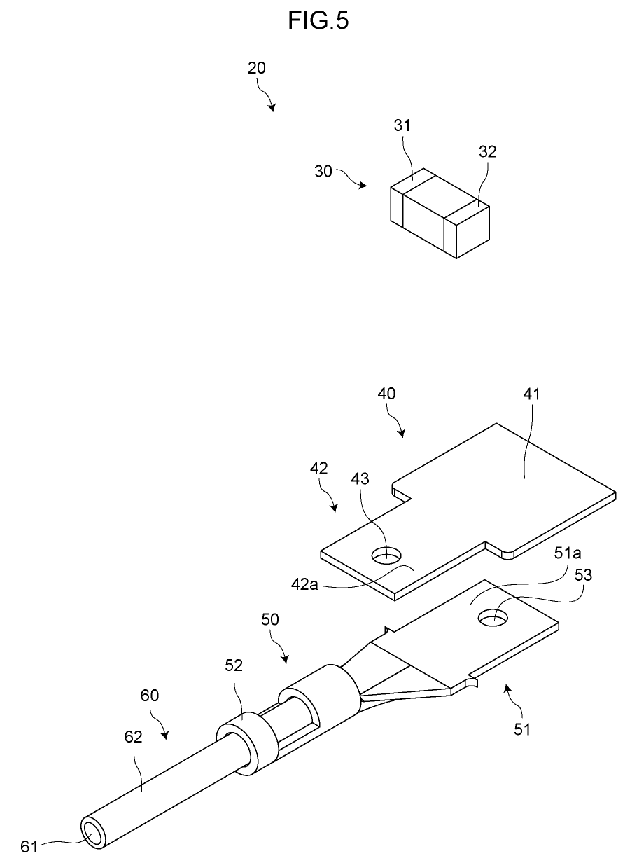

The wiring component 60 includes a conductor unit 61 that has one end connected directly electrically to the second terminal fitting 50 and the other end connected electrically directly or indirectly to the battery monitoring unit (FIGS. 3 and 5). The wiring component 60 includes an insulating coating 62 that has an electrically insulating property and covers the battery monitoring unit side from at least one end of the conductor unit 61 in a terminal (FIGS. 3 and 5). The wiring component 60 described here is a linear conductor that includes a conductor unit 61 formed in a linear shape. Specifically, the wiring component 60 is an electric wire in which a core wire serving as the conductor unit 61 is covered with the insulating coating 62 that has an electrically insulating property, and directly electrically connects the wiring connection unit 52 to one end of the conductor unit 61 in the terminal.

For example, in the wiring component 60, the insulating coating 62 is peeled off in the terminal to expose one end of the conductor unit 61. In this case, as the wiring connection unit 52, a unit formed as a caulking crimp unit to be caulked and crimped to one end (that is, the core wire of the end of the electric wire) of the conductor unit 61 may be applied. For example, as the wiring component 60, a component in which one end of the conductor unit 61 is covered with the insulating coating 62 in the terminal may be used. In this case, as the wiring connection unit 52, a unit formed as a pair of pressure contact blades that makes a cut in the insulating coating 62 at the end of the wiring component 60 and sandwiches one end of the conductor unit 61 (the core wire of the terminal of the electric wire) may be applied. The wiring connection unit 52 illustrated here is formed as a caulking crimp unit.

In the second terminal fitting 50 illustrated here, the second electrical connection unit 51 and the wiring connection unit 52 are adjacent to each other in the direction orthogonal to the arrangement direction. The wiring connection unit 52 is caused to draw out the wiring component 60 in a direction adjacent thereto and along a plane of the second electrical connection unit 51.

The wiring component 60 may be a flat wiring member such as a flexible printed circuit board in which the conductor unit 61 is formed as a wiring pattern (not illustrated). In this case, in the wiring component 60, the conductor unit 61 for each of the second terminal fittings 50 in the plurality of fuse units 20 is formed, and one end of the conductor unit 61 is provided at a terminal of a branch portion branched from the body for each of the second terminal fittings 50. One end of the conductor unit 61 is connected directly electrically to the wiring connection unit 52 by, for example, laser welding, soldering, or the like.

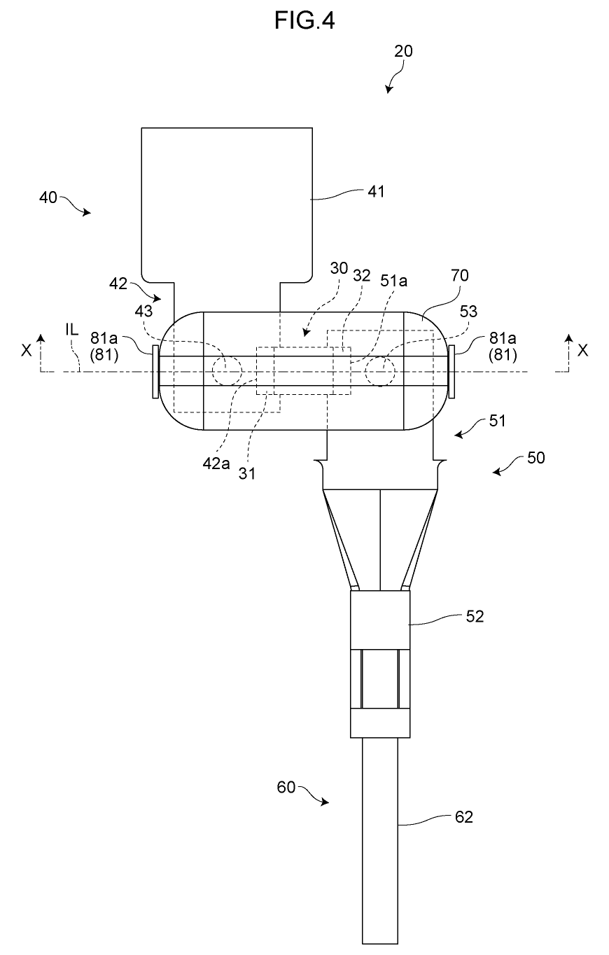

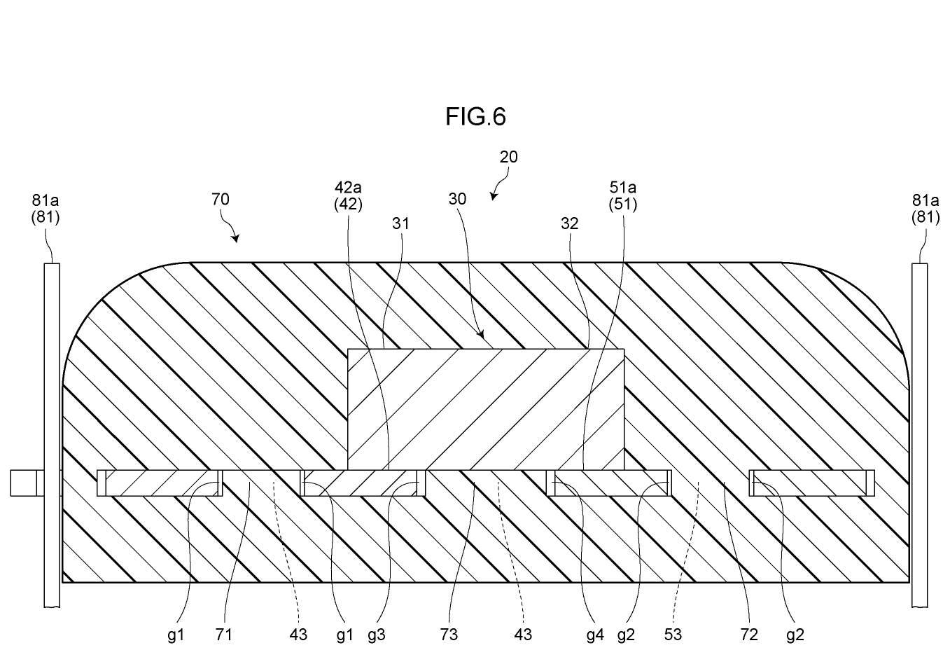

The fuse unit 20 includes a coating resin unit 70 that has an electrically insulating property and encloses the first electrical connection unit 42, the second electrical connection unit 51, and the circuit protection component 30 (FIGS. 3, 4, and 6). The fuse unit 20 includes a pair of coating holding units 81 that hold the coating resin unit 70 sandwiched from one end and the other end in the arrangement direction and cause the battery module BM to hold the coating resin unit 70 (FIGS. 4 and 6).

The coating resin unit 70 encloses the first electrical connection unit 42, the second electrical connection unit 51, and the circuit protection component 30 to inhibit energization between the first electrical connection unit 42 and the second electrical connection unit 51. The coating resin unit 70 can inhibit, for example, short-circuiting between the first electrical connection unit 42 and the second electrical connection unit 51 due to dew condensation water. For example, the coating resin unit 70 is a solidified product of a liquid thermosetting resin material (so-called thermosetting potting material) that is supplied to and enclosed around the first electrical connection unit 42, the second electrical connection unit 51, and the circuit protection component 30. The coating resin unit 70 is formed by curing the liquid resin material supplied to the first electrical connection unit 42, the second electrical connection unit 51, and the circuit protection component 30 by heating, and then cooling the resin material.

Here, in the first electrical connection unit 42, a first through hole 43 positioned on a side opposite to the first connection surface 42a in the arrangement direction with respect to the second connection surface 51a is formed (FIGS. 3 to 6). In the second electrical connection unit 51, a second through hole 53 positioned on the opposite side to the second connection surface 51a in the arrangement direction with respect to the first connection surface 42a is formed (FIGS. 3 to 6). The first through hole 43 and the second through hole 53 are formed in a circular shape that has a hole diameter smaller than an interval between the first electrical connection unit 42 and the second electrical connection unit 51 in the arrangement direction.

The coating resin unit 70 includes a first resin portion 71 formed in a hole of the first through hole 43 and a second resin portion 72 formed in a hole of the second through hole 53 (FIG. 6). Since the coating resin unit 70 contracts during cooling after heating, a gap is generated between the first resin portion 71 and the inner peripheral surface in the hole of the first through hole 43, and a gap is generated between the second resin portion 72 and the inner peripheral surface in the hole of the second through hole 53. For example, the coating resin unit 70 has a first gap g1 between the inner peripheral surfaces at both ends in the arrangement direction in the hole of the first through hole 43, and has a second gap g2 between the inner peripheral surfaces at both ends in the arrangement direction in the hole of the second through hole 53 (FIG. 6). That is, in the hole of the first through hole 43 illustrated here, the first resin portion 71 forms the first gap g1 having the same size between the inner peripheral surfaces on one side and the other side in the arrangement direction. In the hole of the second through hole 53 illustrated here, the second resin portion 72 forms the second gap g2 having the same size between the inner peripheral surfaces on one side and the other side in the arrangement direction. Here, since the first through hole 43 and the second through hole 53 have the same hole diameter and the same volume in the hole, the first gap g1 and the second gap g2 have the same size.

The coating resin unit 70 includes a third resin portion 73 formed between the first electrical connection unit 42 and the second electrical connection unit 51 (FIG. 6). In the coating resin unit 70, a volume of the third resin portion 73 formed between the first electrical connection unit 42 and the second electrical connection unit 51 is greater than a volume of the first resin portion 71 and the second resin portion 72 formed in the holes of the first through hole 43 and the second through hole 53. Thus, in the coating resin unit 70, an amount of contraction during cooling after heating in the third resin portion 73 is greater than an amount of contraction during cooling after heating in the first resin portion 71 and the second resin portion 72. Accordingly, the coating resin unit 70 has the third gap g3 formed with the first electrical connection unit 42 in the arrangement direction between the first electrical connection unit 42 and the second electrical connection unit 51 and greater than the first gap g1, and has the fourth gap g4 formed with the second electrical connection unit 51 in the arrangement direction between the first electrical connection unit 42 and the second electrical connection unit 51 and greater than the second gap g2 (FIG. 6). The third resin portion 73 illustrated here has the third gap g3 and the fourth gap g4 having the same size in the arrangement direction respectively between itself and the first electrical connection unit 42 and between itself and the second electrical connection unit 51.

The pair of coating holding units 81 is disposed on an imaginary line IL in the arrangement direction in which the first through hole 43 of the first electrical connection unit 42, the first connection surface 42a of the first electrical connection unit 42, the second connection surface 51a of the second electrical connection unit 51, and the second through hole 53 of the second electrical connection unit 51 are arranged, and holds the coating resin unit 70 by sandwiching the coating resin unit 70 from one end and the other end in the arrangement direction (FIG. 4). For example, the coating holding unit 81 includes a locking portion 81a having a cantilever shape that is arranged to face the coating resin unit 70 in the arrangement direction and locks the coating resin unit 70 (FIGS. 4 and 6). The pair of coating holding units 81 sandwiches and holds the coating resin unit 70 from one end and the other end in the arrangement direction with the locking portions 81a.

The conductive module 1 according to the present embodiment includes a housing component (hereinafter referred to as a "module housing component") 80 that is assembled to the battery module BM and houses the connection conductor 10 and the fuse unit 20 (FIG. 1), and the module housing component 80 includes a pair of coating holding units 81.

The module housing component 80 includes a housing chamber (hereinafter referred to as a "conductor housing chamber") 80a that houses the connection conductor 10 and a housing chamber (hereinafter referred to as a "unit housing chamber") 80b that houses the fuse unit 20 (FIG. 1). For example, the module housing component 80 includes the conductor housing chamber 80a for each of the connection conductors 10 connected to each of the electrode terminals BCb of the electrode terminal group BCc. On the other hand, the module housing component 80 includes the unit housing chamber 80b in which the fuse unit 20 for each connection conductor 10 is collectively housed.

In the unit housing chamber 80b, a bottom wall 82 (FIG. 1) is disposed between the fuse unit 20 and the battery cell BC, and the pair of coating holding units 81 protrudes from the bottom wall 82. In the unit housing chamber 80b, the wiring component 60 (electric wire) of each fuse unit 20 is routed to the battery monitoring unit side. In each wiring component 60 (electric wire), the other end of the end routed to the battery monitoring unit side is connected to a connector 65 (FIG. 1). Each wiring component 60 (electric wire) is connected indirectly electrically to the battery monitoring unit via the connector 65.

When the wiring component 60 is a flat wiring member, the unit housing chamber 80b houses the wiring component 60 (flat wiring member) having the conductor unit 61 connected to the second terminal fitting 50 of each fuse unit 20 (not illustrated).

For example, the module housing component 80 includes a first housing member (hereinafter referred to as a "first module housing member") 80A (FIG. 1) and a second housing member (hereinafter referred to as a "second module housing member", not illustrated) assembled and fixed to each other. The first module housing member 80A and the second module housing member are formed of a material that has an electrically insulating property, such as a synthetic resin.

The first module housing member 80A has a space portion for forming the plurality of conductor housing chambers 80a and the unit housing chamber 80b at an assembly completion position with the second module housing member, and a pair of coating holding units 81 is provided on the bottom wall 82 of the unit housing chamber 80b. The second module housing member is molded as a cover member that covers an opening of each space portion.

In the fuse unit 20, for example, when the second terminal connection unit 11B of the connection conductor 10A is pulled away from the first terminal connection unit 11A in the arrangement direction in accordance with the change in the inter-electrode terminal pitch due to thermal expansion of the battery cells BC, movement of the second terminal connection unit 11B is transmitted to the first terminal fitting 40. In the fuse unit 20, when the first through hole 43 is not provided in the first electrical connection unit 42 of the first terminal fitting 40, there is a possibility of the first electrical connection unit 42 moving in the arrangement direction with respect to the coating resin unit 70 by the size of the third gap g3 at the maximum, and there is a possibility of an overload being applied between the first connection surface 42a of the first electrical connection unit 42 and the first electrode 31 of the circuit protection component 30. However, in the fuse unit 20, the first electrical connection unit 42 moves in the arrangement direction by the size of the first gap g1 with respect to the coating resin unit 70, and the inner peripheral surface is locked to the first resin portion 71 of the coating resin unit 70 in the hole of the first through hole 43, and thus a load applied between the first connection surface 42a of the first electrical connection unit 42 and the first electrode 31 of the circuit protection component 30 can be inhibited to be low. Accordingly, the fuse unit 20 can keep the connection state between the first connection surface 42a of the first electrical connection unit 42 and the first electrode 31 of the circuit protection component 30.

In the fuse unit 20, for example, when the second terminal connection unit 11B of the connection conductor 10A approaches the first terminal connection unit 11A in the arrangement direction in accordance with the change in the inter-electrode terminal pitch due to thermal contraction of the battery cells BC, movement of the second terminal connection unit 11B is transmitted to the first terminal fitting 40. In the fuse unit 20, the first electrical connection unit 42 moves in the arrangement direction (that is, a direction opposite to that during thermal expansion) with respect to the coating resin unit 70 by the size of the first gap g1, and the inner peripheral surface is locked to the first resin portion 71 of the coating resin unit 70 in the hole of the first through hole 43, and thus a load applied between the first connection surface 42a of the first electrical connection unit 42 and the first electrode 31 of the circuit protection component 30 can be inhibited to be low. Accordingly, the fuse unit 20 can keep the connection state between the first connection surface 42a of the first electrical connection unit 42 and the first electrode 31 of the circuit protection component 30.

Furthermore, in the fuse unit 20, when the second terminal fitting 50 receives a force in the arrangement direction from the battery monitoring unit side (for example, when a force is received in the arrangement direction from the wiring component 60) and the second electrical connection unit 51 of the second terminal fitting 50 moves in the arrangement direction with respect to the coating resin unit 70 by the size of the second gap g2, the inner peripheral surface is locked to the second resin portion 72 of the coating resin unit 70 in the hole of the second through hole 53. Thus, in the fuse unit 20, a load applied between the second connection surface 51a of the second electrical connection unit 51 and the second electrode 32 of the circuit protection component 30 can be inhibited to be low, and thus a connection state between the second connection surface 51a of the second electrical connection unit 51 and the second electrode 32 of the circuit protection component 30 can be kept.

As described above, the fuse unit 20 according to the present embodiment can withstand a change in the inter-electrode terminal pitch of the battery cells BC, which can improve the durability. The conductive module 1 according to the present embodiment includes the fuse unit 20, which can achieve effects similar to those obtained by the fuse unit 20.

In the fuse unit 20 and the conductive module 1 according to the present embodiment, the first terminal fitting 40 is prepared as a component different from the connection conductor 10. However, the fuse unit 20 and the conductive module 1 may be applied to one component (in other words, the first electrical connection unit 42 of the first terminal fitting 40 is molded as a part of the connection conductor 10) in which the first terminal fitting 40 and the connection conductor 10 (particularly, the connection conductor 10A) are integrated.

In the fuse unit according to the present embodiment, for example, when one terminal connection unit of the connection conductor is pulled away from the other terminal connection unit in the arrangement direction in accordance with a change in inter-electrode terminal pitch, or when one terminal connection unit of the connection conductor approaches the other terminal connection unit in the arrangement direction in accordance with a change in inter-electrode terminal pitch, the first electrical connection unit moves in the arrangement direction with respect to the coating resin unit, and the inner peripheral surface is locked to the coating resin unit in the hole of the first through hole. Therefore, a load applied between the first connection surface of the first electrical connection unit and the first electrode of the circuit protection component can be inhibited to be low. Thus, the fuse unit can keep a connection state between the first connection surface of the first electrical connection unit and the first electrode of the circuit protection component. As described above, the fuse unit according to the present embodiment can withstand a change in inter-electrode terminal pitch between the battery cells, which can improve the durability thereof. The conductive module according to the present embodiment includes the fuse unit, which can achieve an effect similar to that obtained by the fuse unit.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a circuit protection component configured to fuse a fusible portion when an overcurrent flows between a connection conductor that is connected directly electrically to two electrode terminals of a pair of battery cells of a battery module in which a plurality of battery cells are arranged in an arrangement direction, the two electrode terminals being adjacent to each other in the arrangement direction, and a battery monitoring unit that monitors a battery state of the battery cells;
a first terminal fitting including a conductor connection unit to be connected directly electrically to the connection conductor and a first electrical connection unit provided with a first connection surface for directly electrically connecting a first electrode of the circuit protection component, the first terminal fitting having a flat plate shape protruding from the connection conductor in a direction orthogonal to the arrangement direction in a state where the first connection surface is oriented in the arrangement direction;
a second terminal fitting including a flat plate-shaped second electrical connection unit provided with a second connection surface for directly electrically connecting a second electrode of the circuit protection component, and connected indirectly electrically to the battery monitoring unit;
a coating resin unit having an electrically insulating property and enclosing the first electrical connection unit, the second electrical connection unit in which the second connection surface is disposed at an interval in the arrangement direction on the same plane with respect to the first connection surface, and the circuit protection component disposed across the first connection surface and the second connection surface; and
a pair of coating holding units configured to hold the coating resin unit by sandwiching the coating resin unit from one end and the other end in the arrangement direction and allow the battery module to hold the coating resin unit,
wherein the connection conductor is deformable in the arrangement direction in accordance with a change in an interval between the two electrode terminals in the arrangement direction, and
wherein, in the first electrical connection unit, a first through hole formed to be positioned on a side opposite to the second connection surface in the arrangement direction with respect to the first connection surface is provided with a hole diameter less than an interval between the first electrical connection unit and the second electrical connection unit in the arrangement direction,
wherein, in the second electrical connection unit, a second through hole formed to be positioned on a side opposite to the first connection surface in the arrangement direction with respect to the second connection surface is provided with a hole diameter less than the interval between the first electrical connection unit and the second electrical connection unit, and
wherein the pair of coating holding units is disposed on an imaginary line in the arrangement direction in which the first through hole, the first connection surface, the second connection surface, and the second through hole are arranged.

2. The fuse unit according to claim 1, wherein the coating resin unit has a first gap between inner peripheral surfaces at both ends in the arrangement direction in the hole of the first through hole, has a second gap between inner peripheral surfaces at both ends in the arrangement direction in the hole of the second through hole, has a third gap greater than the first gap with the first electrical connection unit in the arrangement direction between the first electrical connection unit and the second electrical connection unit, and has a fourth gap formed with the second electrical connection unit in the arrangement direction between the first electrical connection unit and the second electrical connection unit and greater than the second gap.

3. The fuse unit according to claim 1, wherein the coating resin unit is a solidified product formed of a liquid thermosetting resin material that is supplied to and enclosed around the first electrical connection unit, the second electrical connection unit, and the circuit protection component.

4. The fuse unit according to claim 2, wherein the coating resin unit is a solidified product formed of a liquid thermosetting resin material that is supplied to and enclosed around the first electrical connection unit, the second electrical connection unit, and the circuit protection component.

5. The fuse unit according to claim 3, further comprising:
a wiring component interposed between the second terminal fitting and the battery monitoring unit,
wherein the wiring component includes a conductor unit that has one end connected directly electrically to the second terminal fitting and the other end connected electrically directly or indirectly to the battery monitoring unit.

6. The fuse unit according to claim 4, further comprising:
a wiring component interposed between the second terminal fitting and the battery monitoring unit,
wherein the wiring component includes a conductor unit that has one end connected directly electrically to the second terminal fitting and the other end connected electrically directly or indirectly to the battery monitoring unit.

7. A conductive module comprising:
a connection conductor connected directly electrically to two electrode terminals of a pair of battery cells of a battery module in which a plurality of battery cells are arranged in an arrangement direction, the two electrode terminals being adjacent to each other in the arrangement direction;
a fuse unit configured to indirectly electrically connect the connection conductor to a battery monitoring unit that monitors a battery state of the battery cell; and
a housing component assembled to the battery module and configured to house the connection conductor and the fuse unit,
wherein the connection conductor is deformable in the arrangement direction in accordance with a change in an interval between the two electrode terminals in the arrangement direction,
wherein the fuse unit includes
a circuit protection component that fuses a fusible portion when an overcurrent flows between the connection conductor and the battery monitoring unit,
a first terminal fitting including a conductor connection unit to be connected directly electrically to the connection conductor and a first electrical connection unit provided with a first connection surface for directly electrically connecting a first electrode of the circuit protection component, the first terminal fitting having a flat plate shape protruding from the connection conductor in a direction orthogonal to the arrangement direction in a state where the first connection surface is oriented in the arrangement direction,
a second terminal fitting including a flat plate-shaped second electrical connection unit provided with a second connection surface for directly electrically connecting a second electrode of the circuit protection component, and connected indirectly electrically to the battery monitoring unit,
a coating resin unit having an electrically insulating property and enclosing the first electrical connection unit, the second electrical connection unit in which the second connection surface is disposed at an interval in the arrangement direction on the same plane with respect to the first connection surface, and the circuit protection component disposed across the first connection surface and the second connection surface, and
a pair of coating holding units configured to hold the coating resin unit by sandwiching the coating resin unit from one end and the other end in the arrangement direction and allow the battery module to hold the coating resin unit,
wherein, in the first electrical connection unit, a first through hole formed to be positioned on a side opposite to the second connection surface in the arrangement direction with respect to the first connection surface is provided with a hole diameter less than an interval between the first electrical connection unit and the second electrical connection unit in the arrangement direction,
wherein, in the second electrical connection unit, a second through hole formed to be positioned on a side opposite to the first connection surface in the arrangement direction with respect to the second connection surface is provided with a hole diameter less than the interval between the first electrical connection unit and the second electrical connection unit, and
wherein the pair of coating holding units is provided in the housing component and is disposed on an imaginary line in the arrangement direction in which the first through hole, the first connection surface, the second connection surface, and the second through hole are arranged.
